(19) United States
(12) Patent Application Publication
(10) Pub. No.: US 2003/0183449 A1
(43) Pub. Date: Oct. 2, 2003

(54) Fall arresting hook for use on ladders

(76) Inventor: Stanley Thomas Martin, Mt. Sterling, KY (US)

Correspondence Address: Stanley Thomas Martin, 106 Sterling Avenue, Mt. Sterling, KY, 40353, US

(21) Appl. No.: 10/361,276

(22) Filed: Feb. 10, 2003

Related U.S. Application Data
(60) Provisional application No. 60/356,048, filed on Feb. 11, 2002.

(51) Int. Cl. A62B 37/00

(52) U.S. Cl. 182/8

(57) ABSTRACT

This invention helps prevent persons who climb ladders from falling from said ladders. It consists of one or more fall arresting devices which hook over the rungs of a ladder. Used in conjunction with a safety harness and connecting tethers, this invention becomes an adjunct to the human hand, preventing the climber from falling to the ground in the event that the climber's hands should lose their grip. It works even when the rungs of a ladder are covered with ice.

### CROSS REFERENCE TO RELATED APPLICATIONS

This application is related to Provisional Patent Application No. 60/356,048, with a filing date of Feb. 11, 2002.

### BACKGROUND OF THE INVENTION

This invention relates to safety equipment, and more specifically to devices and systems for arresting falls from ladders. More than ever before, thanks to the expanding communications industry, ladders are in use across the world—and more people than ever must climb these ladders in order to service and maintain cell and broadcasting towers. Prior art for arresting falls utilizes safety ropes and belay systems, operated with the assistance of another person; or track systems, whereby the person climbing the ladder is tethered to an automatic braking device which runs either in a track or attaches to a rope or cable secured to the side of the ladder. This prior art, for the most part, works well, but has certain limitations. Systems utilizing belay ropes and belayers require that the belay rope first be attached to the top of the ladder. Doing so usually requires that someone—without a safety backup—first climb the ladder. Also, if the ladder is very tall, such as those attached to broadcasting towers, the weight of the belay rope and the associated rope frictions and elasticities make this system totally impractical. A braking device which runs in a track, or along a steel cable, usually works fairly well, but can often jam, making climbing slow and difficult. Also, virtually all of the fall arrest systems which use automatic braking devices will not work when covered with ice.

Certain prior art, such as that described in U.S. Pat. No. 4,496,025, attach to a climber's feet and hook to the rungs of ladders. Such devices are not designed to arrest falls, but to simply provide a stable surface on which to stand.

### BRIEF SUMMARY OF THE INVENTION

The present invention does not use mechanical brakes or safety ropes, but instead provides a person climbing a ladder with one or more fall arresting hooks which cannot lose their grip on the rungs of the ladder. In use, the climber grasps a fall arresting hook and places it over the appropriate rung as the ladder is being climbed. The fall arresting hook is connected, via a tether, to a safety harness worn by the climber. In the event that the climber loses his grip and falls, the resulting fall would be no further than allowed by the tether. By using two fall arresting hooks, one in each hand, a person can climb ladders of any height in a normal manner, without encumbrance, and with a very high degree of safety—even when the rungs are covered with ice. The climber can also stop and rest or perform work because—unlike human hands—the fall arresting hooks cannot fatigue and come loose.

### BRIEF DESCRIPTION OF THE DRAWINGS

FIG. 1 illustrates the basic design of this invention.

FIG. 2 is a side elevation of this invention, showing a portion of an attached tether.

FIG. 3 illustrates this invention in use by a person climbing a ladder.

FIG. 4 illustrates how this invention is held in the hand, and a means by which it can be secured to the hand.

FIG. 5 illustrates a second embodiment of this invention which can be used on ladders with large or odd-shaped rungs, and which features a centrally located handgrip.

FIG. 6 illustrates a third embodiment of this invention which is useful when climbing rungs that are not horizontally oriented.

### DETAILED DESCRIPTION

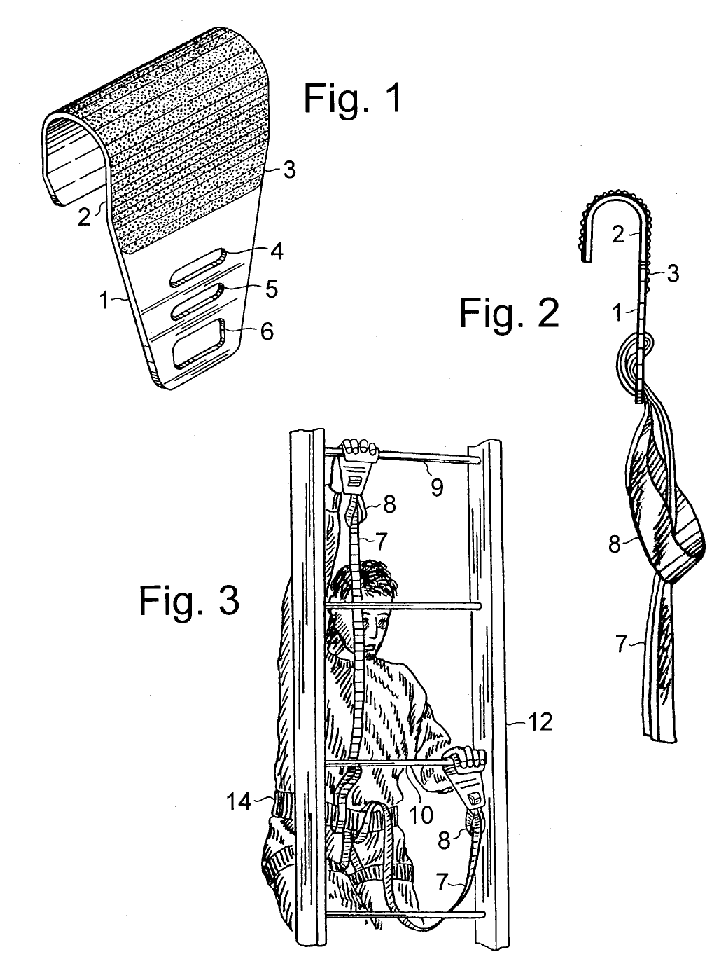

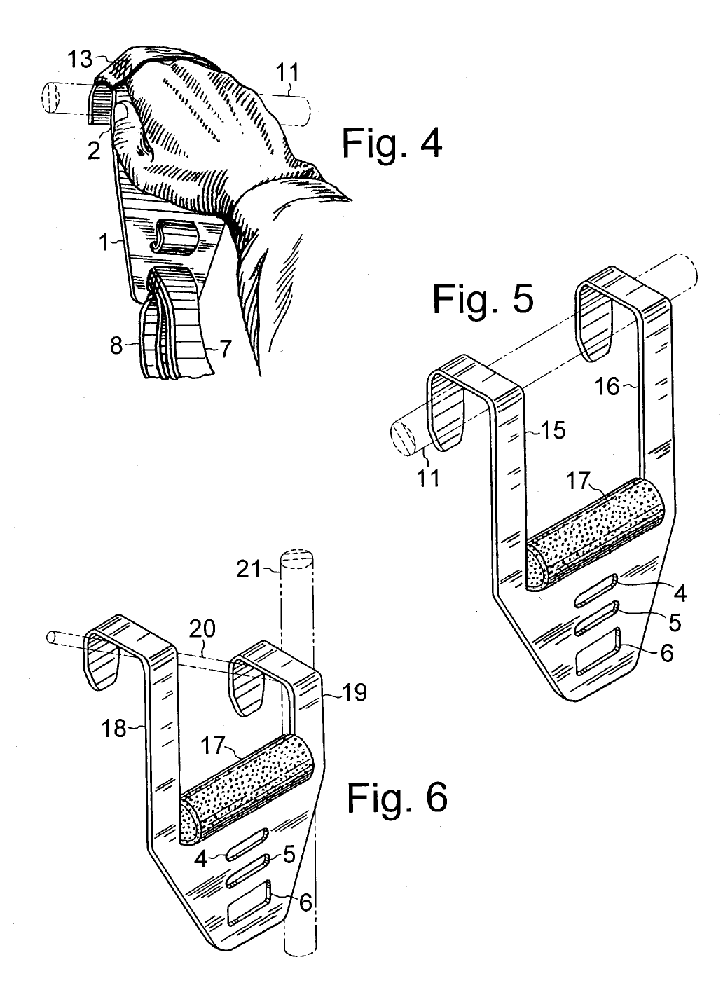

As can be seen in FIGS. 1, 2, 3, and 4 this invention consists of a hook-like device made of metal or other strong material. Solid, heavy materials like stainless or steel sheet can be used for fabrication, as can lightweight materials such as aluminum, titanium, or composites utilizing glass, carbon, or other fibers. It could also be made with a heavy skeleton frame covered over with a rigid or semirigid skin. This invention can be generally divided into a flat lower region 1, and a curved upper region 2 which has been bent into a simple hook with a radius of 180 degrees and parallel sides. The inside dimension of this upper region 2 must be of sufficient width to hook over the rungs 9 and 10 of the ladder 12 being climbed, as illustrated in FIG. 3, and over the phantom rung 11, as illustrated in FIG. 4; preferably with sufficient clearance to fit over said rungs if they are covered with ice. For comfort and safety the external dimensions of this upper region 2 should be such that the user can easily and comfortably grip the device. It will be obvious, to those skilled in the art, that this invention could be fabricated with a different radius of bend than shown herein, and in a manner which includes reinforcing ridges, flanges, or other means for increasing strength and rigidity.

The surfaces on each side of this invention (where the finger tips and palm make contact) can be roughened, or covered by knurling or other slip-resistant surface treatment, in order to improve the ease of gripping. FIGS. 1 & 2 illustrate this invention with an elastomeric coating 3 applied to the upper region where the hand makes contact, thereby providing a surface which is padded, insulated, and slip-resistant.

Near the bottom of this invention, well below where the climber's palm makes contact, are apertures 4, 5, and 6 which enable connecting this invention to a safety harness via a tether 7. This arrangement of slotted apertures forms a buckle system which enables the user to conveniently adjust the length of a tether 7 made of webbing. The tether 7 shown is made of tubular webbing sewn into a long loop. Although not necessary to the proper function of this invention, the end of said loop 8 nearest the buckle can be looped over the tether portion, as illustrated in FIGS. 2 and 3, thereby making it impossible for the tether to come out of the buckle should the webbing accidentally slip. It will be obvious, to those skilled in the art, that the apertures for attaching a tether to this invention can be of any shape, size, or number. It should be further obvious that said tether can be made of any material deemed practical, and can be attached to this invention via buckles, knots, carabiners, or any other practical means.

FIG. 4 shows a means of securing this invention to the hand during use. A large elastic band 13 is slipped over the device and placed at the top of the hooked upper region 2. In use, the fingers are slipped beneath this band 13. This allows the climber to move this invention from one rung to another without having to tightly grip it, thus reducing the hand fatigue experienced when climbing very tall ladders. It is to be understood that this securing band 13 is not necessary to the safe operation of this invention, and its use may at times be contraindicated. It also does not have to be made of elastic material or be attached in the manner shown in FIG. 4.

FIG. 3 shows this invention in normal use. As can be seen, one device is held in the climber's left hand, and another is held in the right hand. Both devices are connected to the climber's safety harness 14 by tethers 7 which are adjusted to the shortest length that will readily allow hooking to the rungs of the ladder 12 being climbed. To use this invention, the climber simply grasps one in each hand and hooks them over the appropriate rungs as the ladder 12 is being climbed. By alternately hooking on to the rungs, just as in normal ladder climbing, progress up or down the ladder can be made. Used in this fashion, only the fall arresting hook actually makes contact with a given rung, and just as in normal ladder climbing, at least one hand is on a rung at any given moment. During the climb, if the climber's hand should lose its grip, the fall arresting hook remains hooked onto the rung and the climber falls no further than permitted by the tether. For resting or working, both fall arresting hooks can be placed on a single rung, thus insuring optimum safety. It is to be understood that a single fall arresting hook will provide a certain amount of safety when climbing, but having one in each hand usually makes for the greatest safety.

As is obvious, this invention does not lock onto the rungs of a ladder, but is held in place by the climber's hand, by gravity, or by the pull of the tether. A locking means, although easily achieved in various ways, is not necessary for the safe use of this invention, and could actually prove hazardous. Having to unlock this invention each time it is removed from a rung would greatly slow the progress of movement on a ladder, thereby increasing the level of fatigue experienced by the climber and in turn increasing the odds of an accident.

FIG. 5 illustrates a second embodiment of this invention, which is shown hooked over a horizontal ladder rung 11. As can be seen in the drawing, this embodiment has an upper region featuring two narrow rectangular hooks 15 & 16, instead of the single, wide, radiused hook illustrated in FIGS. 1, 2, 3, and 4. A handgrip 17 is located near the center region of this embodiment, with apertures 4, 5, and 6 located near the bottom. This embodiment can be used for climbing ladders which have very large or odd-shaped rungs. This embodiment is shown fabricated from sheet stock, but it will be obvious to those skilled in the art that this embodiment could be easily fabricated from bar or tube stock, particularly if the tether system employed does not require slotted apertures, as illustrated. It will be further obvious that the handgrip could be located at the bottom, with apertures located in the center region.

FIG. 6 illustrates a third embodiment, similar to the one shown in FIG. 5, except that the hook portions 18 & 19 of this embodiment are of unequal length in order to allow this invention to be used on rungs, such as those found on many broadcasting towers, which are not horizontal. Non-horizontal rung arrangements vary from X-shapes to angled support struts 20 between the vertical posts 21 of a broadcasting tower. For simplicity of illustration, this embodiment is shown fabricated from sheet stock, with hook portions 18 & 19 of a fixed length. It will be obvious, to those skilled in the art, that this embodiment could easily be fabricated from bar or tube stock, and that said hook portions 18 & 19 could be made adjustable in length in order to readily accommodate rungs and struts of various angles. Said hook portions could also be shaped differently than illustrated, and perhaps covered with elastomeric material in order to better conform to slight angular irregularities of said rungs and struts.

The various embodiments of this invention, as described herein, are designed to be tethered to a safety harness of some type. They could instead be tethered to the wrist of the climber, thus dispensing with the need of a harness. It should be understood, however, that although a certain measure of utility could be achieved in this manner, the dangers (such as the tether slipping from the wrist, or shoulder dislocations in the event of a fall) make this a generally impractical method of rigging.

What I claim is:

1. A fall arresting hook, used to prevent persons who climb ladders from falling from said ladders, which consists of a hook-like device which is held in a climber's hand and is hooked on to the rungs of a ladder as it is being climbed, and which is connected via a short tether to a safety harness worn by the climber.

2. A fall arresting hook which includes an integral buckle system for readily adjusting the length of a connecting tether, and a means to secure said hook to the hand of the climber.

3. A fall arresting hook which has adjustable elements for hooking on to ladder rungs which are not horizontal.
